(19) United States
(12) Patent Application Publication
(10) Pub. No.: US 2026/0063222 A1
(43) Pub. Date: Mar. 5, 2026

(54) PREVENTING WEAR OR DAMAGE TO A VALVE STEM ON A VALVE

(71) Applicant: Dresser, LLC, Houston, TX (US)

(72) Inventors: Aurelien Thomas Jules Reau, Flers (FR); Romain Francois Pierre Chenu, Conde-sur-Noireau (FR); Valentin Mercier, Flers (FR); Arnaud Riviere, Couvains (FR); Mickael Olaya, Valdalliere (FR)

(21) Appl. No.: 18/816,027

(22) Filed: Aug. 27, 2024

(51) Int. Cl. F16K 41/02

(52) U.S. Cl. CPC F16K 41/02

(57) ABSTRACT

A packing assembly is configured for use in a valve. These configurations may include a wear part that surrounds a valve stem. The wear part may prevent contact between the valve stem and a packing follower or other part in the valve.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Valves are a type of flow control that operators favor to regulate flow of material (or “process fluid”) on their process lines. These devices may comprise a valve body that houses valve “trim,” typically a cage, a closure member, and a seat. A superstructure like a bonnet (or cover) may secure to the valve body. The bonnet may have a through-bore to receive a valve stem that connects the closure member to an actuator. Packing material may reside in the through-bore and surround the valve stem to prevent any leak of process fluid that might escape the valve body into the through-bore.

### SUMMARY

The subject matter of this disclosure relates to improvements to construction of valves and other flow controls. Of particular interest are embodiments that can protect the valve stem from damage. These embodiments may adopt designs that avoid or prevent contact between the valve stem and parts of the flow control that, in most cases, are made of materials hard enough to wear, erode, or scratch the valve stem. This feature, in turn, avoids damage to the valve stem that can frustrate use of the packing material to seal with the valve stem. This seal is critical to prevent “fugitive” emissions, which are small amounts of fluids that emanate from in or around components on flow controls, typically the packing material.

### DRAWINGS

This specification refers to the following drawings:

FIG. 1 depicts a schematic diagram of an exemplary embodiment of a packing assembly;

FIG. 2 depicts a schematic diagram of an example of the packing assembly of FIG. 1;

FIG. 3 depicts a perspective view of an example of a wear part for use in the packing assembly of FIG. 2;

FIG. 4 depicts an elevation view of the cross-section from the side of exemplary structure for a flow control that includes the wear part of FIG. 2;

FIG. 5 depicts a perspective view from the side of another exemplary structure for a flow control that includes a wear part;

FIG. 6 depicts an elevation view of the cross-section from the side of another exemplary structure for a flow control that includes a wear part; and

FIG. 7 depicts a perspective view of an example of the flow control of FIG. 4.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

The discussion now turns to describe features of the examples shown in the drawings noted above. These features address wear on parts that may affect seals and other facets of flow controls, like valves or control valves. Other examples and embodiments are within the scope of this disclosure.

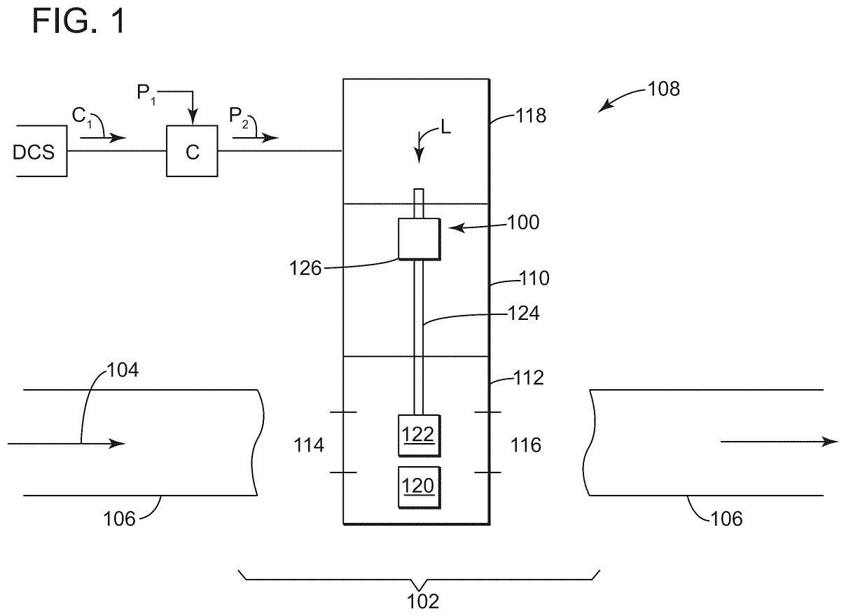

FIG. 1 depicts a schematic diagram of an exemplary embodiment of a packing assembly 100. This embodiment is found in a distribution network 102, typically designed to carry material 104 through conduit 106. The packing assembly 100 is part of a flow control 108 that may integrate into the network 102. The flow control 108 may include a superstructure 110. As shown, a valve body 112 with openings (e.g., an inlet 114 and an outlet 116) may reside on one side of the superstructure 110. An actuator 118 may reside on the other side of the superstructure 110. Inside of the valve body 112, the device may include a seat 120 and a closure member 122, which can move relative to the seat 120. A valve stem 124 may couple the closure member 122 with the actuator 118. In one implementation, the packing assembly 100 may include a stack 126 of parts that surround the valve stem 124.

Broadly, the packing assembly 100 may be configured to reduce or mitigate wear. These configurations may employ parts with properties that cause these parts to wear or erode faster than other parts in the device. These “wear” parts may comprise materials, for example, plastics, polymers, ceramics, or other “non-metallic” materials that are softer or have a hardness that is less than metals, like steel or stainless steel. These properties are useful to avoid inadvertent damage or wear at interfaces where two parts move relative to one another.

The distribution network 102 may be configured to deliver or move fluids. These configurations may embody vast infrastructure. Material 104 may comprise gases, liquids, solid-liquid mixes, or liquid-gas mixes, as well. The conduit 106 may include pipes or pipelines that often connect to pumps, boilers, and the like. The pipes 106 may also connect to tanks or reservoirs. In many facilities, this equipment forms complex networks to execute a process, like refining raw materials or manufacturing a product.

The flow control 108 may be configured to regulate flow of material 104 through the conduit 106 in these complex networks. These configurations may include valves, control valves and like devices. In some cases, like control valves, the device may include a controller C that is configured to process and generate signals. The controller C may connect to a control network (or “distributed control system” or “DCS”). The control network may maintain operation of all devices on process lines to ensure that material 104 flows in accordance with a process or meets certain process parameters. The DCS may generate control signals Ci with operating parameters that describe or define operation of the flow control 108 for this purpose. Operating hardware in the controller C may employ electrical and computing components (e.g., processors, memory, executable instructions, etc.). These components may also include electro-pneumatic devices that operate on incoming pneumatic supply signal P1, typically instrument air at process facilities. These components may generate an outgoing actuator control signal P2 that is appropriate for the flow control 108 to supply material 104 downstream according to process parameters.

The superstructure 110 may be configured with a robust, industrial design that can support components of the flow control 108. On some types of valves, these configurations may include a “bonnet.” The valve body 112 in these devices is often made of cast or machined metals. This part may have flanges or other connective features at the openings 114, 116. Adjacent pipes 106 may connect or bolt to these flanges to allow material 104 to flow into and out of the device. The valve seat 120 and the closure member 122 may adopt construction that allows the flow control 108 to operate under extreme conditions, including with materials 104 that are caustic or hazardous. In one implementation, the actuator control signal P2 may pressurize the inside of the actuator 118. The pressure works with other components in the actuator 118 (like springs and diaphragms) to generate a load L on the valve stem 124. The load L may set the operating condition on the flow control 108, which in turn regulates flow of material 104 through the device to satisfy requirements on the process line. The valve stem 124 may embody an elongated member, for example, a metal rod or shaft that can direct load L from the actuator 118 to the closure member 122. This shaft may have a cross-section that is round or circular; but other shapes may find use in certain applications as well.

The stack 126 may be configured to support the valve stem 124. This configuration may embody, among other things, parts to reduce any likelihood of damage to the valve stem 124, for example, due to metal-on-metal contact. These parts may incorporate materials, like those noted above, to facilitate relative movement at contact points with the valve stem 124. Often, the material will wear faster than the valve stem 124 at these contact points. The design of these parts may also set the valve stem 124 off or away from adjacent “metal” parts of the stack 126. As noted herein, this feature may prevent damage to the valve stem 124 that can allow gas to leak out of the flow control 108.

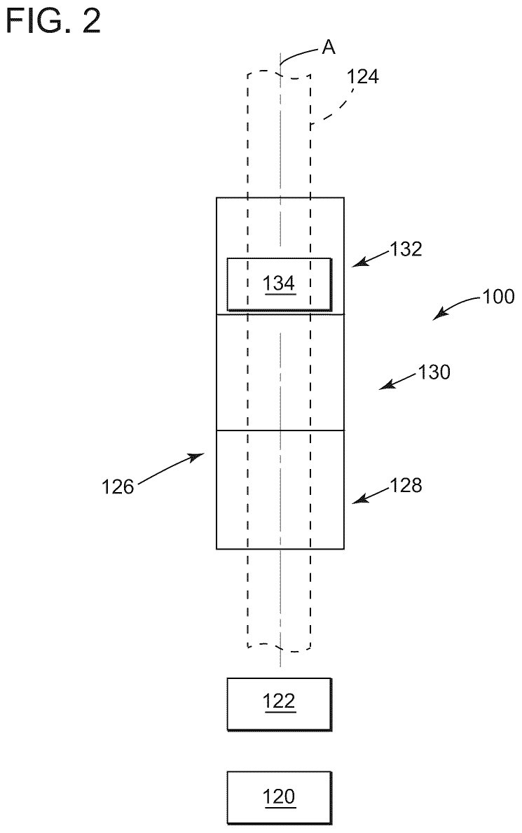

FIG. 2 depicts a schematic diagram of an example of the stack 126 of FIG. 1. This example includes several parts that are configured to receive the valve stem 124. These parts support the valve stem 124 and facilitate relative movement, typically longitudinally translation of the valve stem 124 along axis A of the packing assembly 100. These features permit the closure member 122 to move relative to the seat 120, for example, to control or regulate flow of material 104 (FIG. 1) that flows through the flow control 108 (FIG. 1). In one implementation, the stack 126 may include a bushing 128 that is adjacent packing material 130. A packing follower 132 may reside adjacent packing material 130. The stack 126 may also include a wear part 134 that surrounds at least part of the valve stem 124. The wear part 134 may reside in the packing follower 132, in whole or in part. In some implementations, the wear part 134 may reside adjacent to the follower 132, for example, in space between the follower 132 and packing material 130.

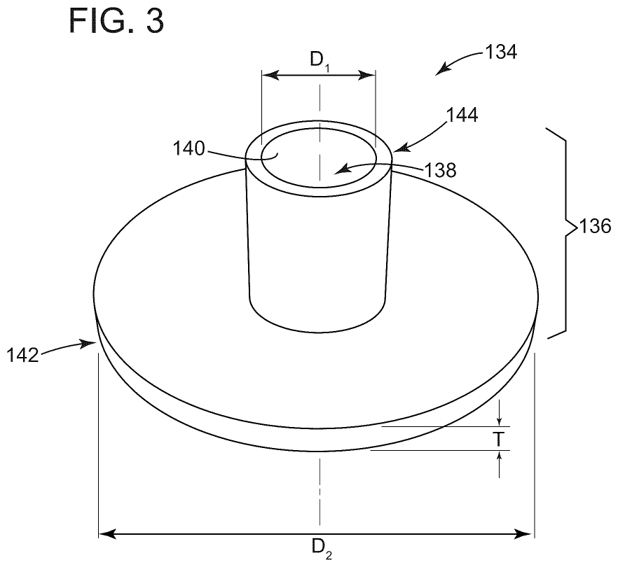

FIG. 3 depicts a perspective view of exemplary structure for the wear part 134. This example includes a body 136, preferably with a shape of a cylinder, although other shapes may prevail as well. The body 136 may have a central bore 138 that defines an inner surface 140 that forms a contact interface with the outer surface of the valve stem 124. The inner surface 140 may have an inner diameter D₁ to receive the valve stem 124 therein. Values for the inner diameter D₁ may allow for a fit that permits the valve stem 124 to translate in the central bore 138. A slip fit or slight friction fit may work for this purpose. In one implementation, the body 136 may have an outer diameter D₂. This dimension may change along the length of the body 136 to define a disc portion 142 with a thickness T and a bore portion 144. At least part of the body 136 may comprise materials with properties, for example, low co-efficient of friction, that facilitates relative movement of the valve stem 124 along or at the contact interface while at the same time preventing leaks of material 104. For example, this material may be found in the bore portion 144 or throughout both the disc portion 142 and the bore portion 144.

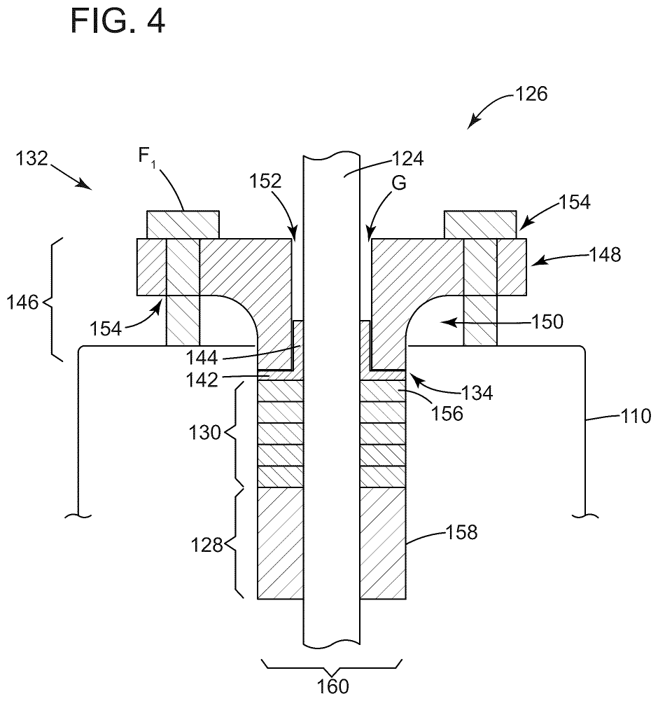

FIG. 4 depicts an elevation view of the cross-section from the side of an example of the wear part 134 of FIG. 3. The packing follower 132 may have a follower body 146 with a flange portion 148, a protruding portion 150 that may extend from the flange portion 148, and a bore 152 and through-holes 154 that may penetrate through the portions 148, 150. The bore portion 144 of the wear part 134 may insert into the bore 152. In one implementation, the bore portion 144 can slide into the bore 152 enough for the disc portion 142 of the wear part 134 to contact the bottom of the follower body 146. A slight interference fit may help to retain the wear part 134 in bore 152. This disclosure contemplates other construction, though, that integrates the wear part 134 into the follower body 146 as a monolithic or unitary part. For example, the design may leverage manufacturing techniques, like additive or 3D manufacturing, that deposit or “print” material for the wear part 134 onto surfaces of the bore 152 or the follower body 146 in general. As shown, the wear part 134 creates a gap G between the outer surface of the valve stem 124 and the inner surface of the bore 152 of the follower body 146. This gap G reduces the potential for fugitive emissions because it prevents contact between the valve stem 124 and the follower body 146 that, in turn, lowers risks of damage, like scratches, to the valve stem 124 that might create a flow path for escaping fluids, like natural gas or other hydrocarbon gasses.

As also shown, the disc portion 142 of the wear part 134 may contact the top of packing material 130. In one implementation, the packing material 130 may embody separate packing rings 156 that stack on top of each other. One of the packing rings 156 at the bottom of this stack may contact the bushing 128, typically a cylindrical, metallic body 158 made of steel, stainless steel, or other metals. In one implementation, one or more parts of the stack 126 may reside in a cavity 160 in the superstructure 110. Fasteners F₁ may populate through-holes 154 to secure the follower body 146 to the superstructure 110. This arrangement may generate a downward force F to retain the stack 126 in the cavity 160 of the structure 110.

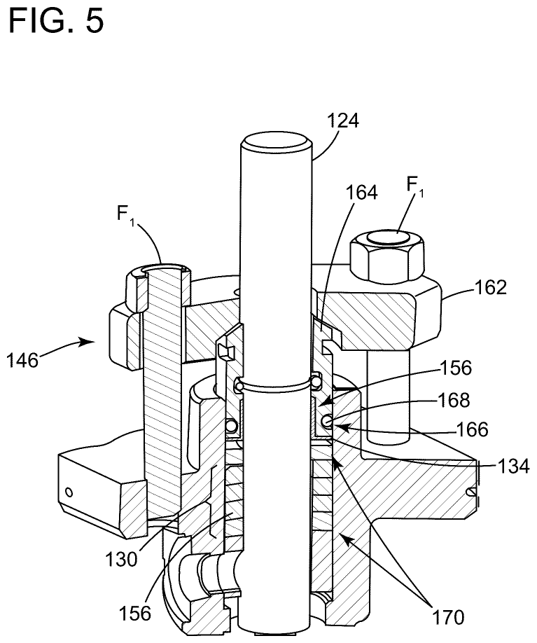

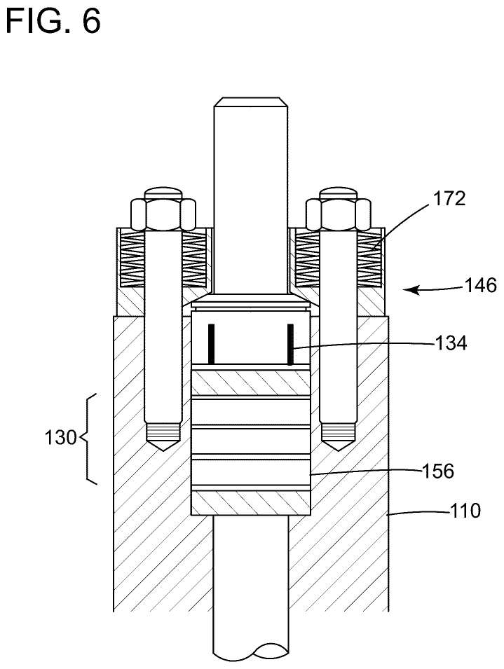

FIGS. 5 and 6 depict other implementations of the wear part 134. In FIG. 5, the follower body 146 includes separate parts 162, 164. The wear part 134 may be inserted into the second part 164, shown to have a lower annular groove 166 that receives an O-ring 168. Anti-extrusion rings 170 may bound the packing rings 156. As best shown in FIG. 6, spring washers 172 may find use to secure the follower body 146 to the superstructure 110.

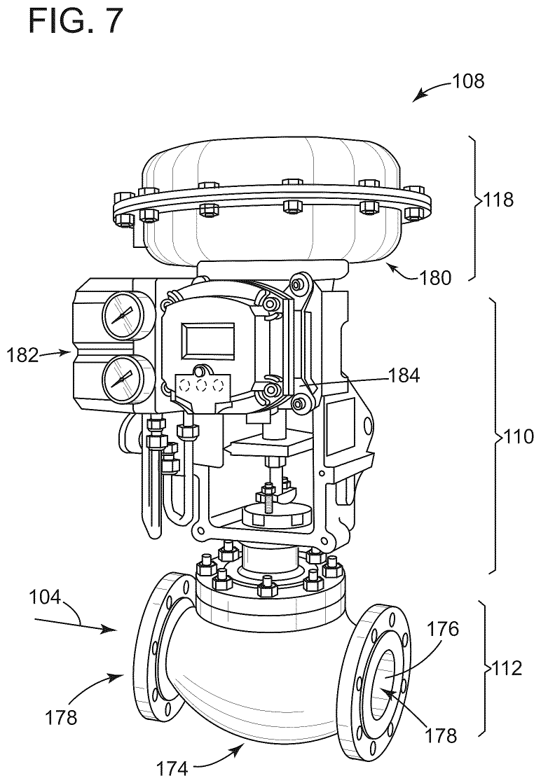

FIG. 7 depicts a perspective view of exemplary structure for the flow control 108. This example reflects structure of a typical globe control valve; however, the disclosure contemplates use of the proposed design in any industrial valve device, including rotary valves like ball valves, butterfly valves, or globe valves. As shown, the valve body 112 may include a fluid coupling 174 that forms a flow path 176 with flanged, open ends 178. The fluid coupling may enclose the valve mechanics, like the closure member 122 and seat 120 (both hidden in the present view). This structure may be useful to regulate process fluids in industrial process lines typical of industries that focus on chemical production, refining production, and resource extraction. The superstructure 110 may secure to the fluid coupling 174. The superstructure 110 may support a pneumatic actuator 118, shown here to have a bulbous housing 180 that is typically two pieces that clamp about the edges to entrap a diaphragm (not shown) round the periphery. A controller 182 may mount onto a bracket 184 that itself either secures to or incorporates as part of the superstructure 110. As also shown, the controller 182 can deliver fluid, for example, instrument air, at appropriate pressure to the pneumatic actuator 118, which utilizes the pressurized fluid to generate a load. Often, the device may include a piston, spring (or springs), or a flexible diaphragm for this purpose. The load may counter pressure of material 104 on an opposite side of the closure member 122 (FIG. 1) to maintain the closure member 122 (FIG. 2) in a desired position relative to the seat 120. This desired position or “set point” may correspond with flow parameters for the material 104 to meet process requirements or parameters.

Considering the foregoing, the improvements herein may extend service life of valves in the field. These improvements reduce any likelihood of wear that can occur because of metal-on-metal interactions between parts of these valves. These features can prevent leaks of material from the device, as well as reduce operator costs to monitor, maintain, or repair valves that incur damage in the field.

This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

1. A valve, comprising:
an actuator;
a valve stem having a first end and a second end, the first end coupled to the actuator;
packing material surrounding the valve stem; and
a wear part adjacent the packing material, the wear part surrounding the valve stem.

2. The valve of claim 1, further comprising:
a packing follower with a bore to receive at least part of the wear part therein.

3. The valve of claim 1, further comprising:
a packing follower comprising a body with a flange portion, a protruding portion extending from the flange portion, and a bore to receive at least part of the wear part in the protruding portion.

4. The valve of claim 1, further comprising:
a packing follower,
wherein the wear part resides at least partially in the packing follower.

5. The valve of claim 1, further comprising:
a packing follower,
wherein the wear part interposes between the packing follower and the packing material.

6. The valve of claim 1, further comprising:
a packing follower with a bore therethrough,
wherein the bore has a diameter that is larger than an outer diameter of the wear part.

7. The valve of claim 1, further comprising:
a packing follower with a bore therethrough,
wherein bore has a diameter that is larger than an outer diameter of the wear part and the valve stem.

8. The valve of claim 1, further comprising:
a packing follower that receives at least part of the wear part therein,
wherein the packing follower and the wear part are made of different materials.

9. The valve of claim 1, further comprising:
a packing follower with a bore,
wherein the wear part comprises a cylinder with a bore portion and a disc portion, and
wherein the disc portion has a diameter that is larger than the diameter of the bore of the packing follower.

10. The valve of claim 1, further comprising:
a bushing disposed on a first side of the packing material; and
a packing follower disposed on a second side of the packing material, the packing follower comprising a bore to receive the valve stem therethrough,
wherein the wear part fits into the bore of the packing follower.

11. A valve, comprising:
a valve stem, and
a packing assembly surround the valve stem, the packing assembly comprising a wear part surrounding the valve stem.

12. The valve of claim 11, wherein the packing assembly comprises individual parts in a stack, wherein the parts comprise a packing follower that receives the wear part.

13. The valve of claim 11, wherein the packing assembly comprises individual parts in a stack, wherein the parts comprise a packing follower that receives the wear part and a bushing.

14. The valve of claim 11, wherein the packing assembly comprises individual parts in a stack, wherein the parts comprise a packing follower that receives the wear part, a bushing, and packing material disposed between the packing follower and the bushing.

15. The valve of claim 11, wherein the packing assembly comprises individual parts in a stack, wherein the parts comprise a packing follower that receives the wear part, a bushing, and packing rings disposed between the packing follower and the bushing.

16. The valve of claim 11, further comprising:
a superstructure with a cavity to receive the packing assembly.

17. The valve of claim 11, further comprising:
superstructure with a cavity to receive the packing assembly; and
an actuator disposed on the superstructure and coupled to the valve stem.

18. The valve of claim 11, further comprising:
superstructure with a cavity to receive the packing assembly;
an actuator disposed on a first side of the superstructure and coupled to the valve stem; and
a valve body disposed on a second side of the superstructure.

19. A valve, comprising:
a superstructure with a cavity;
a valve stem extending into the cavity; and
a stack of parts disposed in the cavity and surrounding the valve stem, the parts comprising:
a packing follower;
packing material;
a bushing; and
a wear part interposed between the packing follower and the packing material, the wear part resident, at least partially, in the packing follower.

20. The valve of claim 19, wherein the wear part and the packing follower are made of different materials.
